(19) United States
(12) Patent Application Publication
(10) Pub. No.: US 2026/0142749 A1
(43) Pub. Date: May 21, 2026

(54) STATISTICAL CODING OF CONTROL SIGNALING INFORMATION

(71) Applicant: QUALCOMM Incorporated, San Diego, CA (US)

(72) Inventors: Umesh PHUYAL, San Diego, CA (US); Rajat PRAKASH, San Diego, CA (US); Masato KITAZOE, Tokyo (JP); Bharat SHRESTHA, San Diego, CA (US); Ozcan OZTURK, San Diego, CA (US)

(21) Appl. No.: 18/952,702

(22) Filed: Nov. 19, 2024

(51) Int. Cl. H04L 1/00

(52) U.S. Cl. CPC H04L 1/0041; H04L 1/0056; H04L 1/0072

(57) ABSTRACT

Certain aspects of the present disclosure provide techniques for statistical encoding of control signaling in wireless communications. In some aspects, the techniques may include obtaining information indicative of a probability distribution of a set of candidate values for a field in control signaling, wherein the field represents a parameter that can be configured with a value selected from the set of candidate values; and communicating control signaling comprising an encoded value for the field, wherein the encoded value is encoded based on an encoding scheme based on the information indicative of the probability distribution.

### FIELD OF THE DISCLOSURE

Aspects of the present disclosure relate to wireless communications, and more particularly, to techniques for control signaling in wireless communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes obtaining information indicative of a probability distribution of a set of candidate values for a field in control signaling, wherein the field represents a parameter that can be configured with a value selected from the set of candidate values; and communicating control signaling comprising an encoded value for the field, wherein the encoded value is encoded based on an encoding scheme based on the information indicative of the probability distribution.

Another aspect provides a method for wireless communication by a network entity. The method includes sending information indicative of a probability distribution of a set of candidate values for a field in control signaling, wherein the field represents a parameter that can be configured with a value selected from the set of candidate values; and communicating control signaling comprising an encoded value for the field, wherein the encoded value is encoded based on an encoding scheme based on the information indicative of the probability distribution.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts example aspects of wireless communications involving statistical encoding of control signaling in accordance with aspects of the present disclosure.

FIG. 6 depicts example aspects of wireless communications involving statistical encoding applied to an ASN.1 enumerated field in accordance with aspects of the present disclosure.

FIG. 7 depicts example aspects of wireless communications involving decoding of an encoded control signaling in accordance with aspects of the present disclosure.

FIG. 8 depicts a process flow for communications in a network between network entities and a UE.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for statistical coding of control signaling in wireless communications.

In wireless communications networks, control signaling, such as radio resource control (RRC) signaling, may be used to communicate control parameters, such as configuration parameters, for communications between wireless communications devices (e.g., user equipments (UEs) and network entities). Such parameters may define specific settings, such as power control configurations, timing configurations, or mobility configurations. For example, the control signaling may include one or more fields, where each field may correspond to one or more control parameters, and a value communicated in the field may represent a value for the one or more control parameters. As an example, a time to trigger (TTT) field may include a value indicative of a TTT for a UE. Such communication of control signaling may utilize communication resources in a wireless communications network, which then may not be used for data communications. In certain aspects, control signaling (e.g., uplink control information, RRC messages, medium access control (MAC) control element (MAC-CE), etc.) can be sent from a network entity to a UE. In certain aspects, control signaling (e.g., downlink control information, RRC messages, MAC-CE, etc.) can be sent from a UE to a network entity.

As wireless communications networks evolve to support diverse deployment scenarios, the efficiency of control signaling may become increasingly important, such as in scenarios with bandwidth constraints such as Internet of Things (IoT) deployments or smart grid applications, or non-terrestrial networks (NTNs). For example, control signaling may make up a larger proportion of signaling in various types of deployments, thereby taking up a larger proportion of available communication resources. Therefore, the control signaling may reduce the efficiency of communications in a wireless communications network, such as by reducing data throughput.

In particular, each field of the control signaling may include a corresponding value. The value may be encoded into one or more bits (e.g., a code point) that represent the value. The greater the number of bits to represent a value, the larger the size of the control signaling, and the more communication resources needed to communicate the control signaling. Therefore, there is a technical problem of how to reduce the size of the control signaling, such as to make more communications resources available for data communications. In particular, there is a technical problem of how to reduce a number of bits used to represent value(s) of field(s) of the control signaling.

Traditional approaches, such as Abstract Syntax Notation One (ASN.1) unaligned packed encoding rules (UPER), may provide efficient and compact encoding schemes for control information. However, some such encoding schemes for encoding values for control signaling may typically assign fixed-length code points to candidate values for a field. For example, where a field can take on four different values {a, b, c, d} (referred to as candidate values for the field), a fixed-length of two bits may be used for the code points for the field, such as 00=a, 01=b, 10=c, and 11=d.

Certain aspects herein provide a technical solution to the technical problem of how to reduce a number of bits used to represent value(s) of field(s) of the control signaling, such as compared to fixed-length code point encoding schemes. For example, certain aspects provide techniques for statistical coding of control signaling. In certain aspects, statistical coding of control signaling includes an encoding scheme used to encode a value of a field of control signaling that is based on information indicative of a probability distribution of a set of candidate values for the field. The probability distribution of the set of candidate values for the field may indicate, for each candidate value of the set of candidate values, a probability the value of the field will be the signaled value. For example, given candidate values {a, b, c, d} for a field, there could be a 95% chance the value is a (as in the actual signaled value is “a” 95% of the time statistically in the communications network), a 2% chance the value is b, a 2% chance the value is c, and a 1% chance the value is d, leading to a probability distribution of {95%, 2%, 2%, 1%}. In certain aspects, instead of using a fixed-length code point encoding scheme to encode the value for the field, a variable-length code point encoding scheme may be used based on the probability distribution, such as where candidate values that are more likely to occur are assigned a relatively shorter length code point, and candidate values that are less likely to occur are assigned a relatively longer length code point. For example, the code points for the field may be 0=a, 10=b, 110=c, and 111=d. One example variable-length code point encoding scheme discussed herein includes Huffman coding (an example of a prefix-free, probability-based encoding scheme), though any suitable such encoding scheme may similarly be used.

In certain aspects, using a variable-length code point encoding scheme based on the probability distribution of candidate values may, on average, utilize a fewer number of bits to signal the field value as compared to a fixed-length code point. For example, a fixed-length code point may always use 2 bits for communicating one of candidate values {a, b, c, d}, while in the proposed example variable-length code point encoding scheme, the average number of bits used for communicating a candidate value among candidate values {a, b, c, d} is 0.95*1+0.02*2+0.02*3+0.01*3=1.08. Accordingly, in certain aspects, an encoding scheme used to encode a value of a field of control signaling that is based on information indicative of a probability distribution of a set of candidate values for the field may provide the technical benefit of a reduced number of bits used to communicate control signaling, thereby reducing signaling overhead, increasing throughput of data, increasing communication efficiency, etc.

In certain aspects, the probability of distribution of candidate values for a field may be based on certain candidate values for a field being used more frequently than others over time such that a given field may more likely have one value than another value. In some aspects, there may be dependencies between parameters represented by a same field and/or by different fields, where the value of one parameter or field affects the probability distribution of candidate values for other parameters or fields. For example, if a first field is configured with a particular value, subsequent fields may have different probabilities of being configured with certain values, or may not need to be configured at all.

In certain aspects, for devices, such as a transmitter of the control signaling and a receiver of the control signaling, to be able to communicate using a coding scheme based on the probability distribution of candidate values, both the transmitter and the receiver may need information indicative of the probability distribution of candidate values. For example, the transmitter may be configured to encode the control signaling based on the coding scheme, and the receiver may be configured to decode the control signaling based on the coding scheme. Accordingly, in certain aspects, at least one of the receiver or transmitter may determine the probability distribution and send information indicative of the probability distribution to the other of the receiver or transmitter. Certain aspects are discussed herein with a network entity as an example transmitter of control signaling and a UE as an example receiver of the control signaling. However, it should be understood that the techniques discussed herein are applicable in other scenarios, such as where the UE may be the transmitter of control signaling and the network entity the receiver of control signaling. Further, certain aspects are discussed herein with a transmitter (e.g., network entity) as an example of the device that determines the probability distribution of candidate values and sends the information indicative of the probability distribution of candidate values to the receiver (e.g., UE). However, it should be understood that the techniques discussed herein are applicable in other scenarios, such as where a receiver (e.g., UE) determines the probability distribution of candidate values and sends the information indicative of the probability distribution of candidate values to the transmitter (e.g., network entity). Accordingly, when the receiver (e.g., UE) determines and provides the probability distribution information to the transmitter (e.g., network entity), the receiver (e.g., UE) may use this information directly for decoding without requiring the transmitter (e.g., network entity) to send it back, while the transmitter (e.g., network entity) may use the received probability distribution information to encode its control signaling transmissions. In certain aspects, one device may communicate the information indicative of the probability distribution of candidate values via one or more of RRC signaling (e.g., one or more RRC messages), a system information block (SIB), or a master information block (MIB) including the information. In certain aspects, one device may communicate the information indicative of the probability distribution of candidate values via a reference to a location where the information can be retrieved by another device, such as a uniform resource locator (URL). For example, the reference may be communicated in any suitable signaling, such as RRC signaling, SIB, MIB, or the like.

In certain aspects, the information indicative of the probability distribution may be the probability distribution itself (e.g., a statistical table), such as the probabilities that make up the probability distribution. Each device (e.g., transmitter and receiver) may include a data handler configured to utilize the probability distribution to determine the same coding scheme individually at the device.

In certain aspects, the information indicative of the probability distribution may be an order of the candidate values by probability, such as most probable to least probable. Each device (e.g., transmitter and receiver) may include a data handler configured to utilize the order of the candidate values by probability to determine the same coding scheme individually at the device. For example, only the relative probability (order) of candidate values may need to be known, such that more bits are assigned to relatively less probable candidate values, and less bits are assigned to relatively more probable candidate values.

In certain aspects, the information indicative of the probability distribution may be a mapping of the set of candidate values to a set of code points. For example, the mapping may be done such that that more bits are assigned to relatively less probable candidate values, and less bits are assigned to relatively more probable candidate values. Therefore, the mapping may indicate the probability distribution, in that candidate values being mapped to longer code points indicate they are less probable, and candidate values being mapped to shorter code points indicate they are more probable. In certain aspects, the mapping may be a table of candidate values to code points. The mapping may be referred to as a dictionary.

In certain aspects, the device determining the probability distribution of candidate values may do so using one or more techniques, such as based on a network configuration, utilizing an artificial intelligence or machine learning model, or the like. In certain aspects, the probability distribution of candidate values may change over time, such that information indicative of an updated probability distribution is communicated between devices, and used for the coding scheme. In some aspects, such updates may be triggered by observed changes in traffic patterns, device mobility, or application-specific requirements. In some aspects, different probability distribution of candidate values may be determined for different time periods (e.g., times of day), and dynamically used for the different time period to determine different coding schemes for the different time periods. This may provide the technical benefit of reduced number of bits being used for communication, even as the network use changes.

Certain aspects provide for an ability to optionally enable, disable, or switch use of an encoding scheme used to encode a value of a field of control signaling that is based on information indicative of a probability distribution of a set of candidate values for the field. For example, devices may communicate capability information as to whether they are capable of using such an encoding scheme, and only do so if both devices are capable. For example, a UE may indicate to a network entity whether it is capable of utilizing such an encoding scheme. If the UE is capable, the encoding scheme may be used. If the UE is not capable, a different (e.g., legacy) encoding scheme may be used, thereby allowing the technical benefit of compatibility in the network with more devices. In certain aspects, one signaling may be used to indicate that such an encoding scheme is supported in the network, such as sent from the network entity to the UE. Further, a separate signaling may be used to flexibly activate or deactivate the encoding scheme.

For example, certain aspects described herein may maintain compatibility with existing systems while providing enhanced efficiency. For example, while utilizing encoding for control signaling, a fallback to traditional encoding methods may also be supported when needed. This compatibility provides devices that can communicate effectively regardless of their encoding capabilities, while allowing encoding enabled devices to benefit from reduced signaling overhead. Accordingly, the use of encoded signaling may be based on device capabilities and network conditions.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

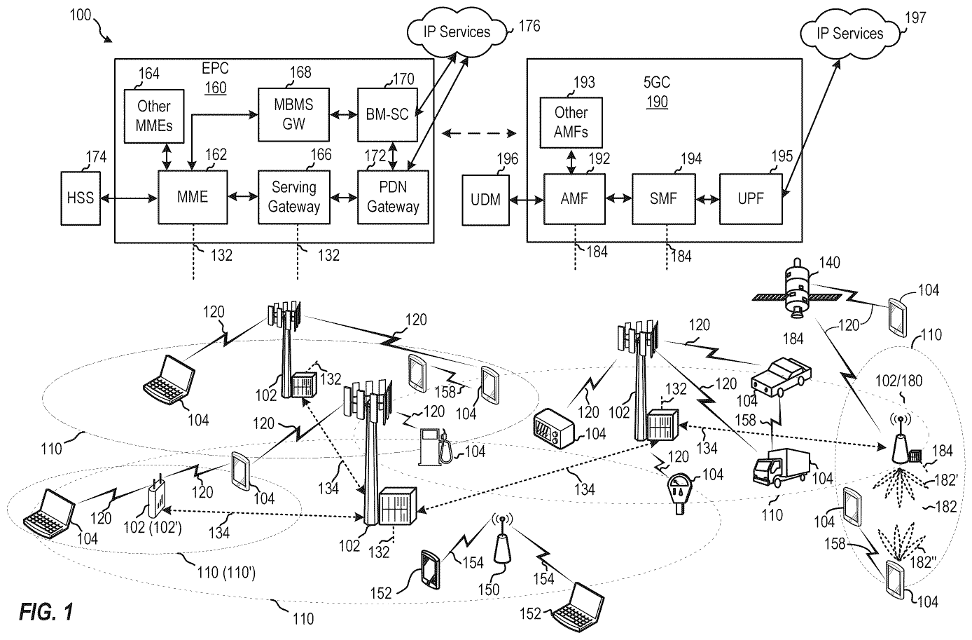

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such, communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

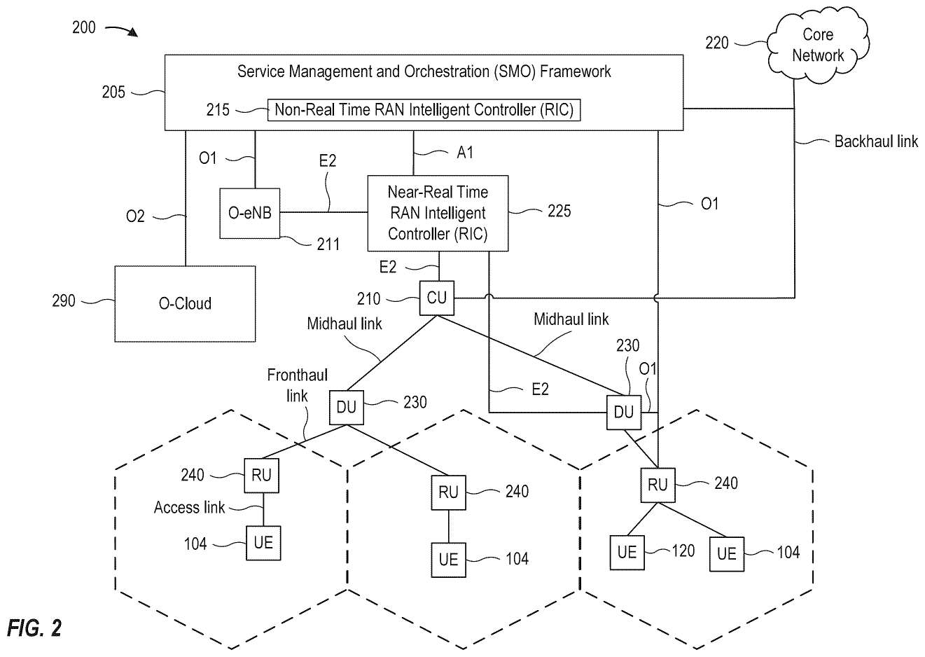

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1 ) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

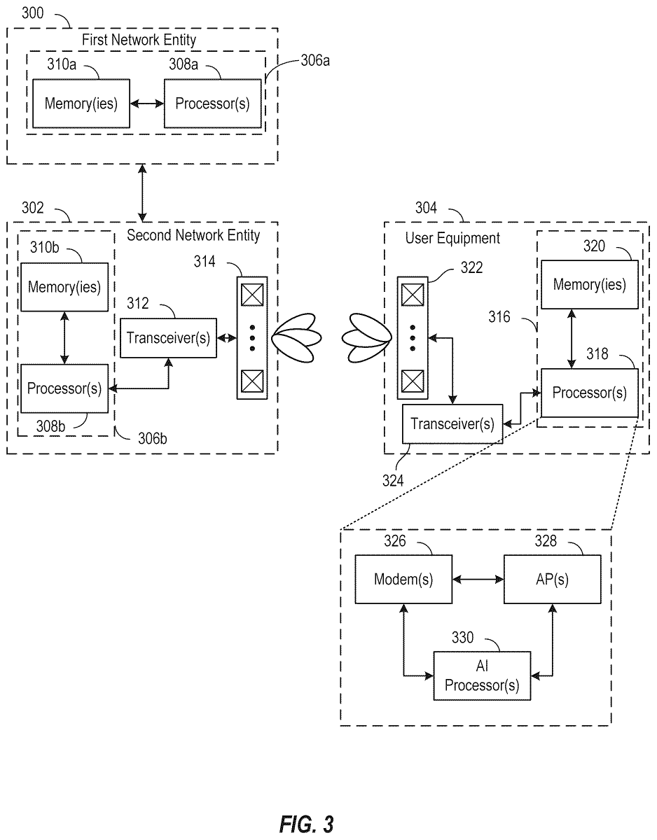

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

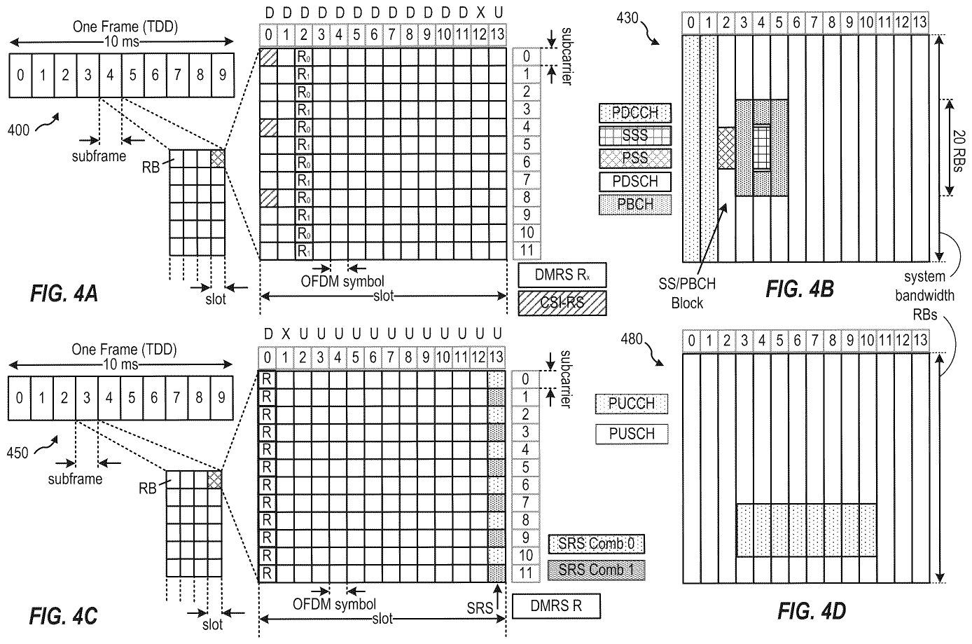

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Statistical Encoding of Control Signaling

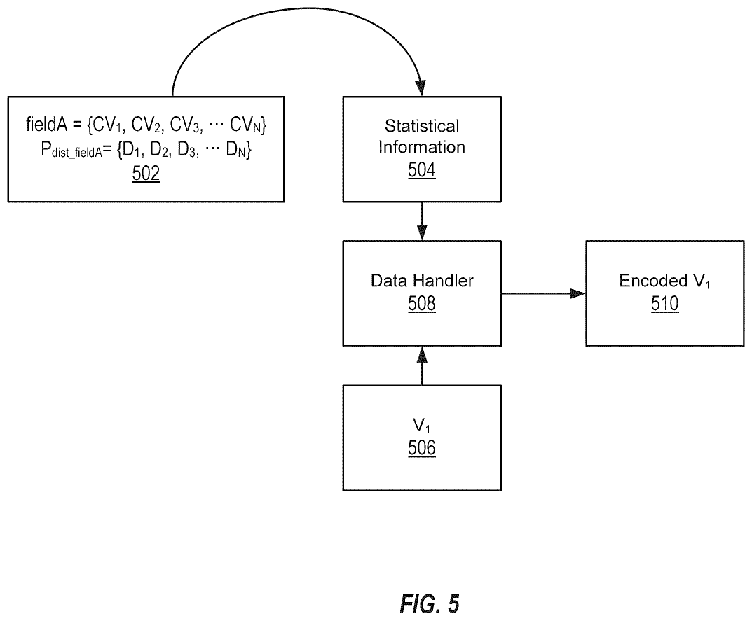

FIG. 5 depicts aspects of wireless communications involving statistical encoding of control signaling in accordance with aspects of the present disclosure. In wireless communication systems, encoding schemes may be applied to efficiently compress data, allowing control signals to occupy fewer resources. In some aspects, encoding schemes may vary in their structure, with some encoding schemes using fixed-length code points that apply uniform code lengths for values, and other encoding schemes using variable-length code points that adapt based on statistical patterns of data usages. For example, probability-based encoding schemes, such as statistical encoding, allow more frequently occurring values to be assigned shorter code points, thus reducing the average bit-length required for transmission.

In certain aspects, a field component 502 may refer to a set of candidate values CVᵢ (where i=1 to N) and information indicative of a statistical distribution (e.g., probability distribution) of each candidate value (e.g., CVᵢ) distribution (Di, where i=1 to N). In some aspects, the candidate values CVᵢ may represent possible values that can be assigned to a field in control signaling. In certain aspects, control signaling may refer to RRC signaling, system information block (SIB) signaling, master information block (MIB) signaling, non-access stratum (NAS) signaling, other control plane messages, or the like. For example, control signaling may include configuration parameters for wireless communication, such as mobility parameters, power control parameters, timing advance parameters, beam management parameters, channel configuration parameters, or other radio resource management parameters. In some aspects, the distribution of such parameters may represent statistical information associated with each candidate value, such as probability distributions or statistical characteristics of the candidate values. For example, statistical information may include relative frequencies of configuration parameter usage, historical patterns of parameter selection, likelihood of parameter combinations, correlations between different parameter values, or network-specific usage patterns. In some aspects, the statistical characteristics may be derived from operational data, machine learning models, or network analytics.

In certain aspects, statistical information 504 may include, for each of one or more fields, information indicative of a respective probability distribution of a respective set of candidate values for the field. For example, as discussed, the statistical information may include the probability distribution (e.g., statistical table) itself, an order of candidate values by probability, or a mapping (e.g., dictionary) of candidate values to code points. In certain aspects, a device may derive statistical information 504 based on one or more of relationships between correlated parameters, parameter dependency structures, transitions between parameter states, network-determined parameters, historical configurations, or learned models. In some aspects, network-determined parameters may be based on observed traffic patterns, network load conditions, user behavior analytics, device capabilities, or performance metrics. Historical configurations may include past parameter selections, frequency of parameter updates, or temporal patterns in parameter usage. Learned models may utilize machine-learning techniques to predict parameter configurations based on network conditions. In some aspects, the distribution and availability of such information may be dependent on configurations from network providers, geographic regions, device types, or UE-specific behaviors.

In certain aspects, the probability distribution of the set of candidate values for a field may be dependent on values selected for other fields in the control signaling. For example, when a first field is configured with a particular value from a set of candidate values, the probability distribution of values for a second field may be affected. For example, certain values may have zero probability or a single value may have 100% probability based on the selected value of the first field. In certain aspects, subsequent fields may not need to be configured at all, effectively changing their probability distribution to a single state. This dependency may be represented in the statistical information, where the probability distribution for subsequent fields becomes heavily weighted toward a particular outcome based on the configuration of preceding fields. In certain aspects, such dependencies may be common in control signaling, where certain parameter combinations are more likely in specific network configurations or operational modes.

In some aspects, network providers may maintain distinct probability distributions of candidate values (e.g., dictionaries) for different service types, such as enhanced Mobile Broadband (eMBB), ultra-reliable low-latency communication (URLLC), or massive machine-type communication (mMTC). In some aspects, geographic regions may require parameter configurations and therefore different probability distributions, depending on local deployment characteristics or regulatory requirements. Additionally, in some aspects, different device types may use specialized probability distributions that may be optimized for their capabilities. In some aspects, a probability distributions selection may be influenced by UE-specific behaviors, including mobility patterns, service subscriptions, and usage profiles.

While either of network entities and UEs may generate and communicate statistical information, (e.g., information indicative of the probability distribution of the set of candidate values for a field), in some aspects, the network entity may determine and distribute this information. For example, network entities may have greater computational resources and access to broader configuration data for gathering and analyzing statistical patterns. Additionally, having the network entity manage statistical information 504 may help to ensure consistency across multiple UEs, while reducing a processing burden on UE devices—which may have limited resources for such analysis.

In certain aspects, the statistical information 504 (e.g., information indicative of the probability distribution of the set of candidate values for a field) may be updated, such as based on various network triggers or operational events. In some aspects, these updates may be triggered by a periodic analysis of network configurations or specific instructions from a controlling entity, such as a network entity. In certain aspects, such updates may be delivered via RRC signaling or other control plane messages. In some aspects, the statistical information 504 may be shared via a uniform resource locator (URL) or indication of a location from which the UE can download updated statistical information.

In certain aspects, value component 506 may represent a specific parameter value (V₁) from the set of candidate values (e.g., {CV₁, CV₂, CV₃, . . . CV_{N}}) for a field. In some aspects, the value component 506 may represent an individual value assigned within that parameter's range. In some aspects, value component 506 may be passed to data handler 508, along with statistical information 504, to facilitate encoding based on the selected parameter value.

In certain aspects, the data handler 508 may be configured to support switchable encoding, such as between encoding schemes based on probability distributions as discussed herein, and other (e.g., legacy) encoding schemes, such as traditional ASN.1 unaligned packed encoding rules (UPER), aligned packed encoding rules (APER), basic encoding rules (BER), distinguished encoding rules (DER), or other standardized encoding schemes that do not utilize statistical compression. In some aspects, this switchable functionality may provide for a dynamic selection between encoding schemes based on network conditions or UE capabilities. In some aspects, the data handler 508 may be configured to adjust encoding schemes based on updated statistical information 504.

In certain aspects, data handler 508 may be configured to implement an encoding scheme based on probability distributions as discussed herein. While Huffman coding may be used in some aspects, the data handler 508 may alternatively employ any one or more of other suitable coding schemes, such as arithmetic coding, dictionary-based methods, or other probability-based encoding approaches, such as depending on the statistical nature of candidate values to be encoded. For example, the selection of encoding scheme may be based on factors such as, but not limited to, the statistical distribution of values, network conditions, processing capabilities of the transmitting and receiving devices, or specific compression requirements. In certain aspects, the encoding scheme may be configured to assign shorter code points to more statistically probable values of the set of candidate values, and longer code points to less statistically probable values of the set of candidate values. In certain aspects, the encoded value 510 may represent the output of data handler 508 and may be generated by encoding the input value from value component 506 based on an encoding scheme that utilizes the statistical information 504 as described above.

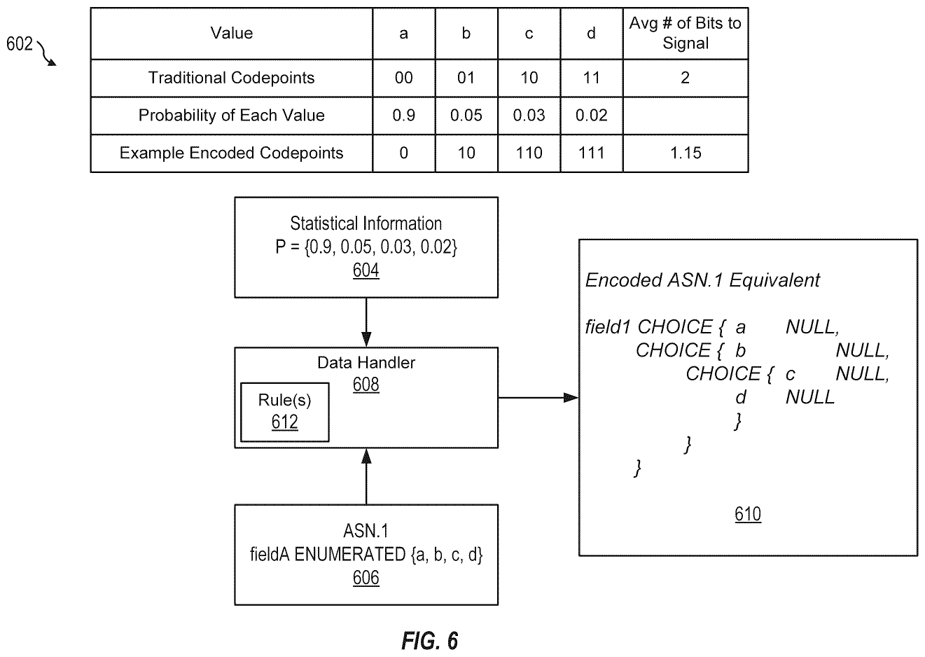

FIG. 6 illustrates example aspects of wireless communications involving statistical encoding applied to an ASN.1 enumerated field in accordance with aspects of the present disclosure. Though ASN.1 enumerated fields are used as an example, any field values may be used. In certain aspects, the comparison table 602 may illustrate differences between traditional encoding techniques and encoding techniques based on probability distributions as discussed herein. For example, the comparison table 602 may include a set of example values (e.g., a, b, c, d) with their corresponding traditional code points (e.g., 00, 01, 10, 11) and example probability distribution based code points (e.g., 0, 10, 110, 111). As indicated in the comparison table 602, the traditional code points may allocate equal bit-length code points to each value, regardless of their probability, while probability distribution based code points may vary in length based on probability. In some aspects, the comparison table 602 depicts probability distributions for each value (e.g., 0.9, 0.05, 0.03, 0.02), illustrating how more probable values may be assigned shorter probability distribution based code points. The comparison table 602 may also indicate efficiency improvements. For example, in some aspects, statistical encoding can reduce the average number of bits from 2 bits (traditional) to 1.15 bits (probability distribution based), thereby enabling bandwidth savings in resource-constrained environments.

In certain aspects, statistical information 604 may store information indicative of the probability distribution of the set of candidate values for a field. For example, the statistical information may be represented as P={0.9, 0.05, 0.03, 0.02}, where each value corresponds to the probability of a particular candidate value being selected. In some aspects, a probability distribution may be updated as network conditions change, such that the encoding process can adapt to current probabilities. As previously described, the statistical information 604 may be periodically communicated, such as from the network entity to the UE via control messages (e.g., radio resource control (RRC), system information blocks (SIBs)) or provided as a downloadable, or the like, such that both a transmitter and a receiver maintain a consistent understanding of value probabilities.

In certain aspects, the value 606 may represent an example enumerated ASN.1 value for a field. In some aspects, the value 606 may be defined using standard ASN.1 syntax, such as “fieldA ENUMERATED {a, b, c, d}” where a, b, c, and d represent possible values that may be assigned to the value 606. In certain aspects, data handler 608 may be configured to process the ASN.1 field and statistical information 604 to generate encoded ASN.1 output 610.

In some aspects, the data handler 608 may include one or more rules 612 that may define how the encoding should be performed. In some aspects, the one or more rules 612 may ensure uniqueness and consistency in the encoding process. For example, when multiple valid (e.g., Huffman) encodings exist for a given probability distribution (e.g., different valid prefix-free codes), the one or more rules 612 may specify a canonical ordering for assigning codes to probabilities (e.g., lexicographical ordering of code points for values with equal probabilities), a specific tree construction algorithm for generating Huffman codes (e.g., always combining the lowest probability nodes when probabilities are equal), or a deterministic mapping between statistical patterns and ASN.1 choice structures. Thus, in some aspects, the one or more rules 612 may ensure that both the provider of the statistical information and the receiver of the statistical information generate identical codings given the same input conditions.

As previously discussed, and in certain aspects, the output 610 may represent the encoded ASN.1 equivalent output generated by the data handler 608. In an example implementation, the output 610 may be structured using ASN.1 CHOICE constructs to create variable-length encodings that correspond to the code points. The hierarchical CHOICE structure may define values where each level represents a binary decision point corresponding to the code points. For example, the encoded format may use nested CHOICE statements with NULL values to create a structure where selecting different paths through the choices produces different length encodings. In some aspects, the structure “field1 CHOICE {a NULL, CHOICE {b NULL, CHOICE {c NULL, d NULL}}}” may result in shorter encodings for more probable values by placing them at shallower levels in the CHOICE hierarchy, allowing for efficient transmission by minimizing the average number of bits needed to represent frequently used values.

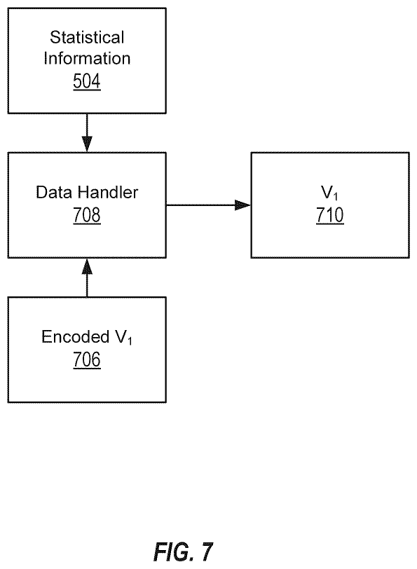

FIG. 7 illustrates example aspects of wireless communications involving decoding of an encoded control signaling in accordance with aspects of the present disclosure. In certain aspects, statistical information 504 may be as described above with respect to FIG. 5. For example, the statistical information 504 may refer to a probability distribution of a set of candidate values for a field and may be used to guide the decoding process of encoded information. In certain aspects, encoded value 706 may represent an input value that has been encoded using statistical information, such as an encoded value generated according to the process described with respect to FIGS. 5 and/or 6.

In certain aspects, data handler 708 may be configured to process the encoded value 706 using the statistical information 504 (e.g., information indicative of the probability distribution of the set of candidate values for a field) to generate a decoded output value 710. The data handler 708 may, in some aspects, perform decoding operations that reverse the statistical encoding process. For example, when the encoded value 706 has been encoded using Huffman coding or other probability-based encoding scheme, the data handler 708 may use the probability distribution information to map the encoded code points back to their original values. In certain aspects, the data handler 708 may apply one or more predefined decoding rules that correspond to the one or more encoding rules 612 described with respect to FIG. 6, thereby ensuring a consistent interpretation of the encoded format.

In certain aspects, output value 710 may represent the output of the decoding process performed by data handler 708. The output value 710 may, in some aspects, correspond to the original value that was encoded using statistical information 504 (e.g., information indicative of the probability distribution of the set of candidate values for a field). For example, if the encoded value 706 represents an encoded enumerated field value, the output value 710 may represent the decoded enumerated value selected from the set of possible values. In certain aspects, the decoded output may be directly used in control signaling or other network functions.

### Example Signaling of Statistical Encoding of Control Signaling

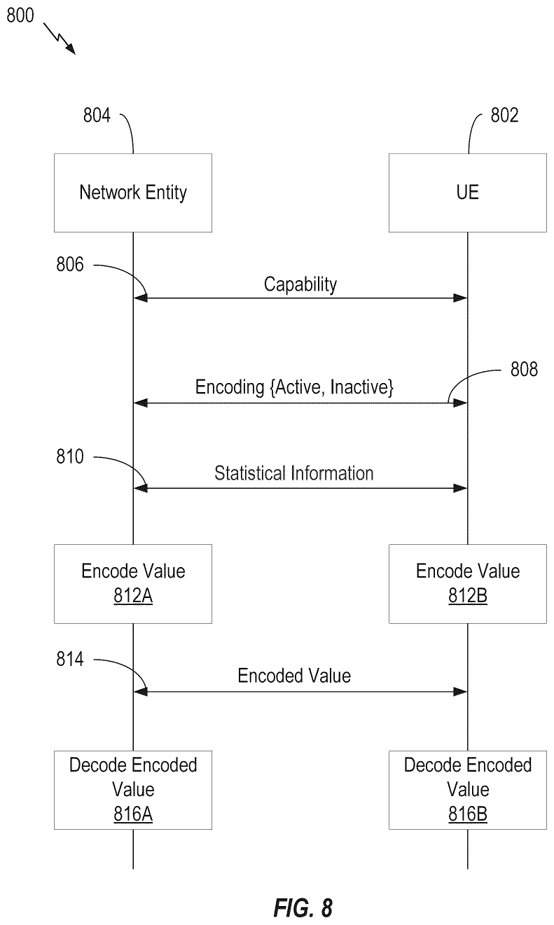

FIG. 8 depicts a process flow 800 for communications in a network between a network entity 804 and UE 802. In some aspects, the network entity 804 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 802 may be an example of UE 104 depicted and described with respect to FIG. 1 or the UE 304 depicted and described with respect to FIG. 3. However, in other aspects, UE 802 may be another type of wireless communications device and network entity 804 may be another type of network entity or network node, such as those described herein. Note that any operations or signaling illustrated with dashed lines may indicate that that operation or signaling is an optional or alternative example.

At 806, a first signal may include capability signaling from the UE 802 to the network entity 804. The capability signaling may indicate whether the UE 802 supports control signaling encoding schemes based on probability distributions of sets of candidate values. In some aspects, this capability signaling may allow the network to determine whether probability distribution based encoding schemes can be used with the UE 802. The capability exchange may include negotiating parameters such as available processing power, memory resources, and any limitations that may affect encoding or decoding of control signals. In certain aspects, this exchange may determine whether the UE 802 can perform real-time decoding (e.g., based on a probability distribution) or if the UE 802 requires pre-configured statistical data (e.g., based on a dictionary) to process encoded messages effectively. In some aspects, the first signal may include capability signaling from the network entity 804 to the UE 802, and may indicate whether the network entity 804 supports control signaling encoding schemes based on probability distributions of sets of candidate values. In certain aspects, this exchange may determine whether the network entity 804 can perform real-time decoding (e.g., based on a probability distribution) or if the network entity 804 requires pre-configured statistical data (e.g., based on a dictionary) to process encoded messages effectively.

At 808, second signal may include a statistical encoding activation or deactivation signaling from the network entity 804 to the UE 802. This signal may indicate whether encoding schemes based on probability distributions of sets of candidate values for fields are to be activated or deactivated for subsequent communications. In some aspects, statistical encoding activation may be based on network conditions, device power constraints, or data rate requirements. In some aspects, the signal may specify which encoding scheme or statistical model will be used when multiple schemes are supported. In some aspects, even if both the UE 802 and network entity 804 support encoding, the encoding may be selectively enabled or disabled based on network conditions, configuration needs, or the potential encoding efficiency gains.

At 808, the signal 808 may include statistical encoding activation or deactivation signaling in the opposite direction, from the network entity 804 to the UE 802. This bidirectional capability may allow either entity to initiate changes in the encoding state. For example, the network entity 804 may activate or deactivate statistical encoding based on real-time network conditions or resource requirements, allowing dynamic adjustment based on network load or resource constraints.

At 810, a subsequent signal may include information indicative of a probability distribution of a set of candidate values for a field, transmitted from the network entity 804 to the UE 802. In some aspects, this information may comprise the probability distribution itself, a mapping of candidate values to code points based on their probabilities, or an ordering of the candidate values by probability. In some examples, the probability distribution may be the same as or similar to the statistical information 504 (FIG. 5). Such information may be pre-computed by the network entity 804 based on historical data, network configurations, and/or may utilize one or more machine learning models. In some aspects, the information indicative of a probability distribution of a set of candidate values may be provided via a system information block (SIB) or radio resource control (RRC) message. The probability distribution may be periodically updated to reflect real-time network conditions, or it may be shared during session setup. In some aspects, the device that determines the probability distribution (whether the UE 802, network entity 804, or otherwise) may provide this information to another device (e.g., the other of the network entity 804 and/or UE 802), which then may use the probability distribution information for encoding or decoding as appropriate.

In some aspects, at 812A the network entity 804 may encode a value according to the probability distribution from 810. In some aspects, at 812B the UE 802 may encode a value according to the probability distribution at 810. In some aspects, at 812A and 812B, encoding may occur in the downlink direction (e.g., network entity 804 to UE 802) and/or the uplink direction (e.g., UE 802 to network entity 804) depending on which direction(s) have statistical encoding activated. Statistical encoding may be activated independently for each direction. For example, statistical encoding may be activated only for downlink transmissions while use conventional encoding for uplink transmissions, or vice versa.

At 814, the encoded value may be communicated from the network entity 804 to the UE 802 and/or from the UE 802 to the network entity 804.

At 816A, the network entity 804 may decode the encoded value according to the information indicative of a probability distribution of a set of candidate values at 810. In some aspects, at 812B the UE 802 may decode the encoded value according to the probability distribution from 810.

Note that the process flow illustrated in FIG. 8 is an example of statistical encoding of control signaling, and aspects of the present disclosure may be applied to statistical encoding of control signaling. Note that the process flow illustrated in FIG. 8 is described herein to facilitate an understanding of statistical encoding of control signaling, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of a User Equipment

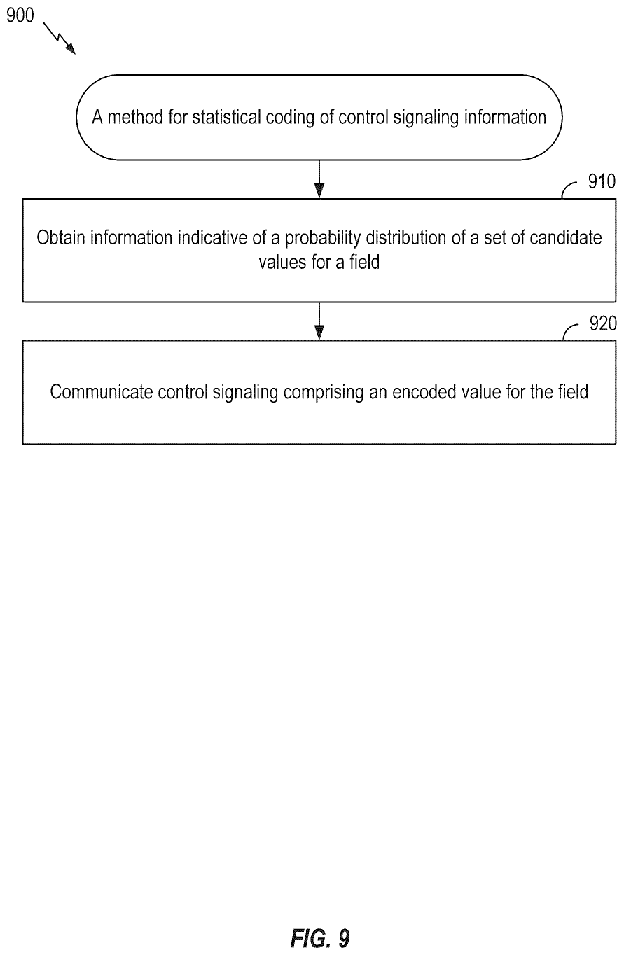

FIG. 9 shows a method 900 for wireless communications by an apparatus, such as UE 104 of FIG. 1 or UE 304 of FIG. 3.

Method 900 begins at step 910 with obtaining information indicative of a probability distribution of a set of candidate values for a field. As described with respect to FIG. 5, this statistical information 504 may include probability distributions representing the likelihood of different parameter values being used in control signaling. Similar to the field component 502 discussed in FIG. 5, the set of candidate values may represent possible configuration parameters that can be assigned to fields in control signaling messages.

Method 900 then proceeds to step 920 with communicating control signaling comprising an encoded value for the field. In some aspects, the encoded value is encoded based on an encoding scheme based on the information indicative of the probability distribution. As illustrated in FIG. 6, the encoding scheme may assign shorter code points to more probable values and longer code points to less probable values, similar to the encoded code points shown in comparison table 602. The data handler 608 (FIG. 6) may implement this encoding using techniques such as Huffman coding or other statistical encoding methods that leverage the probability distribution information.

Method 900 provides a solution directed to the technical challenges of control signaling overhead in wireless communications networks. As described with respect to FIG. 5, traditional approaches using fixed-length encoding for control parameters may fail to account for the varying probabilities of different parameter values, and may lead to inefficient use of signaling resources. In some aspects, by implementing method 900, the UE 802 (FIG. 8) can leverage statistical information about parameter usage patterns to achieve more efficient encoding of control information.

In some aspects, by obtaining probability distribution information as described in step 910, the method 900 enables adaptive encoding that reflects actual network usage patterns. In some aspects, the communication of encoded values in step 920 using probability-based encoding reduces signaling overhead by assigning shorter code points to frequently used values, as demonstrated in the comparison table 602 of FIG. 6. Such reduction in signaling overhead may be beneficial in resource-constrained scenarios such as IoT deployments or smart grid applications, where bandwidth may be limited. Additionally, and in some aspects, method 900 may maintain compatibility with existing systems while providing enhanced efficiency through statistical encoding and allowing for integration into existing wireless communications networks.

In some aspects, step 920 includes causing the user equipment to receive the control signaling; and causing the user equipment to decode the encoded value based on the information indicative of the probability distribution.

In some aspects, step 920 includes causing the user equipment to send the control signaling; and causing the user equipment to generate the encoded value based on the information indicative of the probability distribution.

In some aspects, step 910 includes causing the user equipment to obtain the information indicative of the probability distribution via one or more of: a radio resource control (RRC) message; a system information block (SIB); a master information block (MIB); or a uniform resource locator.

In some aspects, the information indicative of the probability distribution comprises the probability distribution.

In some aspects, the information indicative of the probability distribution comprises an order of the set of values by probability.

In some aspects, the information indicative of the probability distribution comprises a mapping of the set of candidate values to a set of code points.

In some aspects, the encoding scheme is configured to assign shorter code points to more statistically probable values of the set of candidate values, and longer code points to less statistically probable values of the set of candidate values.

In some aspects, the encoding scheme comprises Huffman coding.

In some aspects, method 900 further includes obtaining information indicative of an updated probability distribution of the set of candidate values for the field; and communicating second control signaling comprising a second encoded value for the field, wherein the second encoded value is encoded based on a second encoding scheme based on the information indicative of the updated probability distribution.

In some aspects, method 900 further includes obtaining information that indicates the encoding scheme is supported.

In some aspects, method 900 further includes sending information that indicates the user equipment is capable of communication based on the encoding scheme.

In some aspects, method 900 further includes obtaining information that indicates to activate the encoding scheme.

In some aspects, method 900 further includes obtaining information that indicates to deactivate the encoding scheme.

In some aspects, the control signaling comprises radio resource control (RRC) signaling.

In some aspects, method 900 further includes sending information indicative of a second probability distribution of a second set of candidate values for the field.

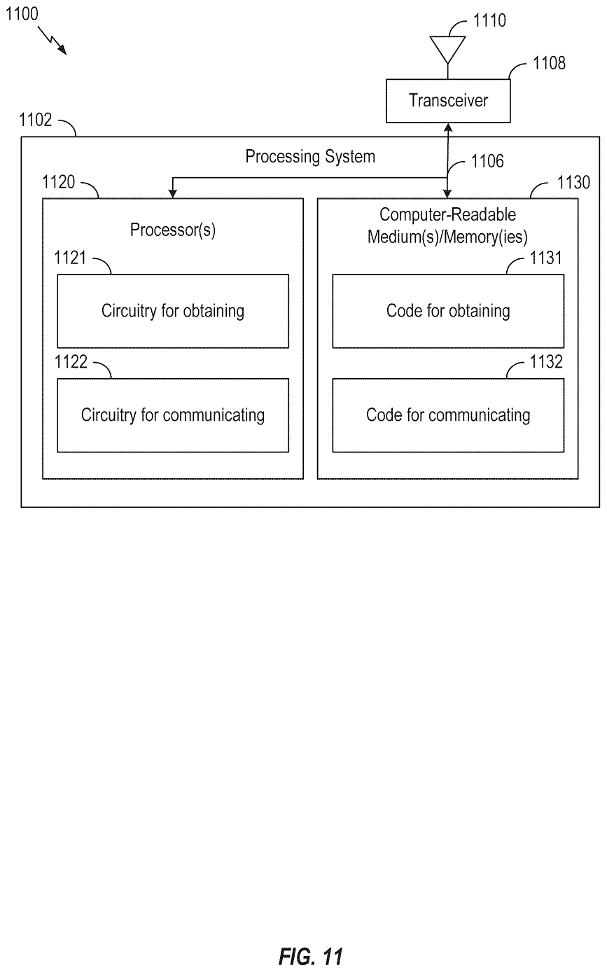

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a Network Entity

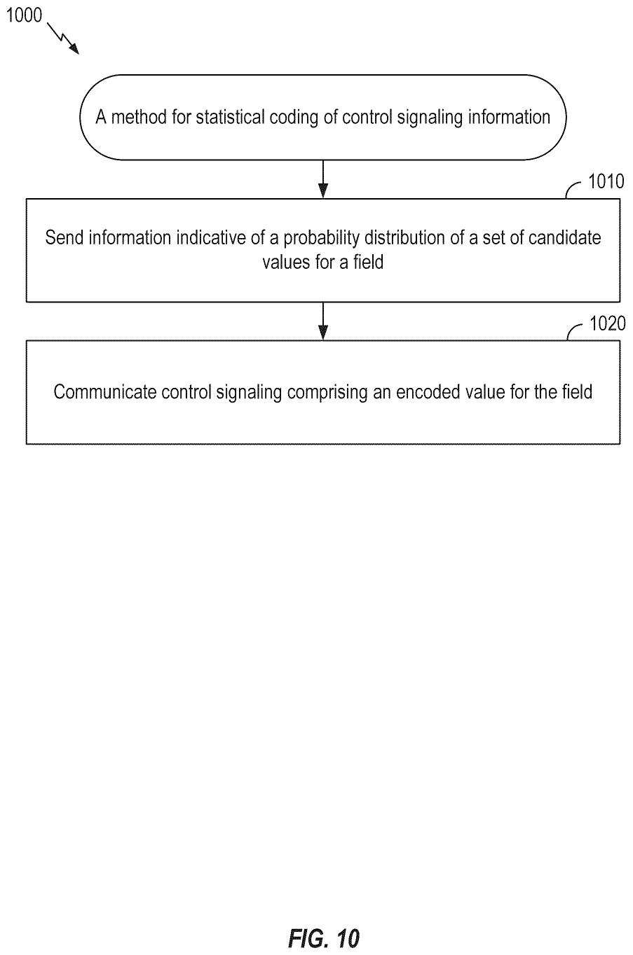

FIG. 10 shows a method 1000 for wireless communications by an apparatus, such as BS 102 of FIG. 1, a first network entity 300 or second network entity 302 of FIG. 3, or a disaggregated base station as discussed with respect to FIG. 2.

Method 1000 begins at step 1010 with sending information indicative of a probability distribution of a set of candidate values for a field. In some aspects, a network entity may provide the information indicative of a probability distribution of a set of candidate values for a field to a UE or other device. In some aspects, the network entity may receive the information indicative of a probability distribution of a set of candidate values for a field from the UE or other device. In some aspects, the flow direction of the probability distribution information may be flexible and may be independent of which device will use such information for encoding. For example, a UE may provide the probability distribution information for the network entity to use in downlink statistical encoding. As another example, the network entity may provide the probability distribution information for the UE to use in uplink statistical encoding.

Method 1000 then proceeds to step 1020 with communicating control signaling comprising an encoded value for the field. In some aspects, the encoded value is encoded based on an encoding scheme based on the information indicative of the probability distribution.

In some aspects, method 1000 further includes determining the probability distribution based on one or more of: a machine-learning model; a communication configuration; or a history of values of the field.

In some aspects, step 1020 includes causing the network entity to send the control signaling; and causing the network entity to generate the encoded value based on the information indicative of the probability distribution.

In some aspects, step 1020 includes causing the network entity to receive the control signaling; and causing the network entity to decode the encoded value based on the information indicative of the probability distribution.

In some aspects, step 1010 includes causing the network entity to obtain the information indicative of the probability distribution via one or more of: a radio resource control (RRC) message; a system information block (SIB); a master information block (MIB); or a uniform resource locator.

In some aspects, the information indicative of the probability distribution comprises the probability distribution.

In some aspects, the information indicative of the probability distribution comprises an order of the set of values by probability.

In some aspects, the information indicative of the probability distribution comprises a mapping of the set of candidate values to a set of code points.

In some aspects, the encoding scheme is configured to assign shorter code points to more statistically probable values of the set of candidate values, and longer code points to less statistically probable values of the set of candidate values.

In some aspects, the encoding scheme comprises Huffman coding.

In some aspects, method 1000 further includes obtaining information indicative of an updated probability distribution of the set of candidate values for the field; and communicating second control signaling comprising a second encoded value for the field, wherein the second encoded value is encoded based on a second encoding scheme based on the information indicative of the updated probability distribution.

In some aspects, method 1000 further includes obtaining information that indicates the encoding scheme is supported.

In some aspects, method 1000 further includes sending information that indicates the network entity is capable of communication based on the encoding scheme.

In some aspects, method 1000 further includes obtaining information that indicates to activate the encoding scheme.

In some aspects, method 1000 further includes obtaining information that indicates to deactivate the encoding scheme.

In some aspects, the control signaling comprises radio resource control (RRC) signaling.

In some aspects, method 1000 further includes sending information indicative of a second probability distribution of a second set of candidate values for the field.

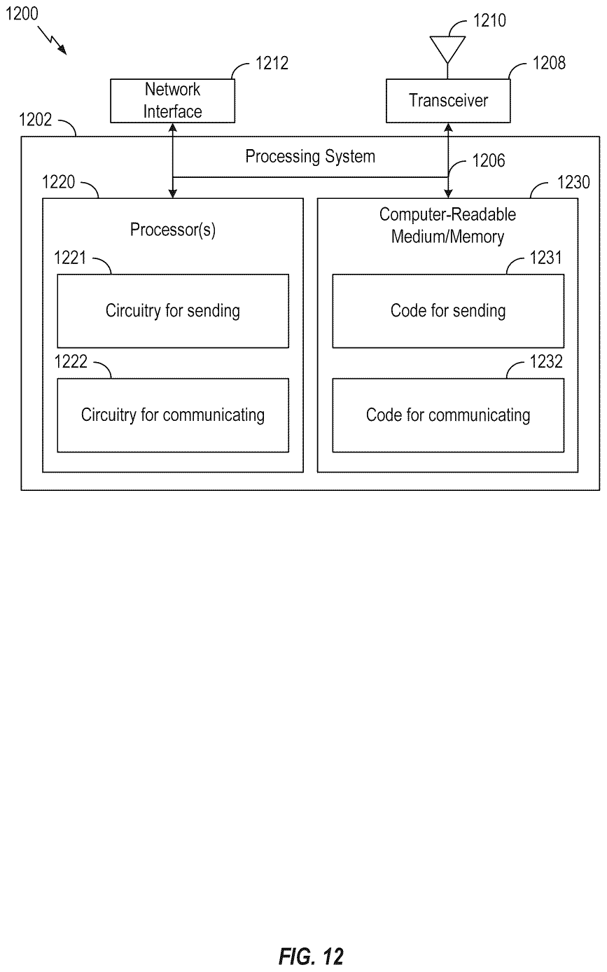

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120 and a computer-readable medium/memory 1130. In various aspects, the one or more processors 1120 may be representative of the one or more processors 318 described with respect to FIG. 3. The one or more processors 1120 are coupled to a computer-readable medium/memory 1130 via a bus 1106. In some aspects, the computer-readable medium/memory 1130 may be representative of the one or more memories 320 described with respect to FIG. 3. The computer-readable medium/memory 1130 is a non-transitory computer-readable medium/memory. In certain aspects, the computer-readable medium/memory 1130 is configured to store instructions (e.g., computer-executable code) that when executed by the one or more processors 1120, cause the one or more processors 1120 to perform the method 900 described with respect to FIG. 9, or any aspect related to the method 900, including any operations described in relation to FIG. 9. Note that reference to a processor performing a function of communications device 1100 may include one or more processors performing that function of communications device 1100, such as in a distributed fashion.

In the depicted example, computer-readable medium/memory 1130 stores code (e.g., executable instructions) for obtaining 1131 and code for communicating 1132. Processing of the code 1131-1132 may enable and cause the communications device 1100 to perform the method 900 described with respect to FIG. 9, or any aspect related to the method 900.

The one or more processors 1120 include circuitry configured to implement (e.g., execute) the code stored in the computer-readable medium/memory 1130, including circuitry for obtaining 1121 and circuitry for communicating 1122. Processing with circuitry 1121-1122 may enable and cause the communications device 1100 to perform the method 900 described with respect to FIG. 9, or any aspect related to the method 900.

More generally, means for communicating, transmitting, sending or outputting for transmission may include the one or more transceivers 324, one or more antennas 322, and/or processing system 316 of the UE 304 illustrated in FIG. 3, transceiver 1108 and/or antenna 1110 of the communications device 1100 in FIG. 11, and/or one or more processors 1120 of the communications device 1100 in FIG. 11. Means for communicating, receiving or obtaining may include the one or more transceivers 324, one or more antennas 322, and/or processing system 316 of the UE 304 illustrated in FIG. 3, transceiver 1108 and/or antenna 1110 of the communications device 1100 in FIG. 11, and/or one or more processors 1120 of the communications device 1100 in FIG. 11.

FIG. 12 depicts aspects of an example communications device configured for wireless communications. In some aspects, communications device 1200 is a network entity, such as BS 102 of FIG. 1, first network entity 300 or second network entity 302 of FIG. 3, or a disaggregated base station as discussed with respect to FIG. 2.

The communications device 1200 includes a processing system 1202 coupled to a transceiver 1208 (e.g., a transmitter and/or a receiver) and/or a network interface 1212. The transceiver 1208 is configured to transmit and receive signals for the communications device 1200 via an antenna 1210, such as the various signals as described herein. The network interface 1212 is configured to obtain and send signals for the communications device 1200 via communications link(s), such as a backhaul link, midhaul link, and/or fronthaul link as described herein, such as with respect to FIG. 2. The processing system 1202 may be configured to perform processing functions for the communications device 1200, including processing signals received and/or to be transmitted by the communications device 1200.

The processing system 1202 includes one or more processors 1220 and a computer-readable medium/memory 1230. In various aspects, one or more processors 1220 may be representative of the one or more processors 308, as described with respect to FIG. 3. The one or more processors 1220 are coupled to the computer-readable medium/memory 1230 via a bus 1206. In certain aspects, the computer-readable medium/memory 1230 is configured to store instructions (e.g., computer-executable code), including code aspects 1231-1232, that when executed by the one or more processors 1220, cause the one or more processors 1220 to perform the method 1000 described with respect to FIG. 10, or any aspect related to method 1000, including any operations described in relation to FIG. 10. The computer-readable medium/memory 1230 is a non-transitory computer-readable medium/memory. Note that reference to a processor of communications device 1200 performing a function may include one or more processors of communications device 1200 performing that function, such as in a distributed fashion.

In the depicted example, the computer-readable medium/memory 1230 stores code (e.g., executable instructions) for sending 1231 and code for communicating 1232. Processing of the code 1231-1232 may enable and cause the communications device 1200 to perform the method 1000 described with respect to FIG. 10, or any aspect related to it.

The one or more processors 1220 include circuitry configured to implement (e.g., execute) the code stored in the computer-readable medium/memory 1230, including circuitry for sending 1221 and circuitry for communicating 1222. Processing with circuitry 1221-1222 may enable and cause the communications device 1200 to perform the method 1000 as described with respect to FIG. 10, or any aspect related to it.

Various components of the communications device 1200 may provide means for performing the method 1000 as described with respect to FIG. 10, or any aspect related to method 1000. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1208, antenna 1210, and/or network interface 1212 of the communications device 1200 in FIG. 12, and/or one or more processors 1220 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1208, antenna 1210, and/or network interface 1212 of the communications device 1200 in FIG. 12, and/or one or more processors 1220 of the communications device 1200 in FIG. 12.

### Example Clauses

Implementation examples are described in the following numbered clauses:

Clause 1: A method for wireless communications, comprising obtaining information indicative of a probability distribution of a set of candidate values for a field in control signaling, wherein the field represents a parameter that can be configured with a value selected from the set of candidate values; and communicating control signaling comprising an encoded value for the field, wherein the encoded value is encoded based on an encoding scheme based on the information indicative of the probability distribution.

Clause 2: The method of Clause 1, wherein communicating the control signaling comprises receiving the control signaling; and the method further includes decoding the encoded value based on the information indicative of the probability distribution.

Clause 3: The method of Clause 1, wherein communicating the control signaling comprises sending the control signaling; and the method further includes generating the encoded value based on the information indicative of the probability distribution.

Clause 4: The method of any one of Clauses 1-3, wherein obtaining the information indicative of the probability distribution comprises obtaining the information indicative of the probability distribution via one or more of: a radio resource control (RRC) message; a system information block (SIB); a master information block (MIB); or a uniform resource locator.

Clause 5: The method of any one of Clauses 1-4, wherein the information indicative of the probability distribution comprises the probability distribution.

Clause 6: The method of any one of Clauses 1-4, wherein the information indicative of the probability distribution comprises an order of the set of values by probability.

Clause 7: The method of any one of Clauses 1-4, wherein the information indicative of the probability distribution comprises a mapping of the set of candidate values to a set of code points.

Clause 8: The method of any one of Clauses 1-7, wherein the encoding scheme is configured to assign shorter code points to more statistically probable values of the set of candidate values, and longer code points to less statistically probable values of the set of candidate values.

Clause 9: The method of any one of Clauses 1-8, wherein the encoding scheme comprises Huffman coding.

Clause 10: The method of any one of Clauses 1-9, further comprising: obtaining information indicative of an updated probability distribution of the set of candidate values for the field; and communicating second control signaling comprising a second encoded value for the field, wherein the second encoded value is encoded based on a second encoding scheme based on the information indicative of the updated probability distribution.

Clause 11: The method of any one of Clauses 1-10, further comprising obtaining information that indicates the encoding scheme is supported.

Clause 12: The method of any one of Clauses 1-11, further comprising sending information that indicates the user equipment is capable of communication based on the encoding scheme.

Clause 13: The method of any one of Clauses 1-12, further comprising obtaining information that indicates to activate the encoding scheme.

Clause 14: The method of any one of Clauses 1-13, further comprising obtaining information that indicates to deactivate the encoding scheme.

Clause 15: The method of any one of Clauses 1-14, wherein the control signaling comprises radio resource control (RRC) signaling.

Clause 16: The method of any one of Clauses 1-15, further comprising sending information indicative of a second probability distribution of a second set of candidate values for the field.

Clause 17: A method for wireless communications, comprising sending information indicative of a probability distribution of a set of candidate values for a field in control signaling, wherein the field represents a parameter that can be configured with a value selected from the set of candidate values; and communicating control signaling comprising an encoded value for the field, wherein the encoded value is encoded based on an encoding scheme based on the information indicative of the probability distribution.

Clause 18: The method of Clause 17, wherein communicating the control signaling comprises receiving the control signaling; and the method further includes decoding the encoded value based on the information indicative of the probability distribution.

Clause 19: The method of Clause 17, wherein communicating the control signaling comprises sending the control signaling; and the method further includes generating the encoded value based on the information indicative of the probability distribution.

Clause 20: The method of any one of Clauses 17-19, further comprising sending the information indicative of the probability distribution via one or more of: a radio resource control (RRC) message; a system information block (SIB); a master information block (MIB); or a uniform resource locator.

Clause 21: The method of any one of Clauses 17-20, wherein the information indicative of the probability distribution comprises the probability distribution.

Clause 22: The method of any one of Clauses 17-20, wherein the information indicative of the probability distribution comprises an order of the set of values by probability.

Clause 23: The method of any one of Clauses 17-20, wherein the information indicative of the probability distribution comprises a mapping of the set of candidate values to a set of code points.

Clause 24: The method of any one of Clauses 17-23, wherein the encoding scheme is configured to assign shorter code points to more statistically probable values of the set of candidate values, and longer code points to less statistically probable values of the set of candidate values.

Clause 25: The method of any one of Clauses 17-24, wherein the encoding scheme comprises Huffman coding.

Clause 26: The method of any one of Clauses 17-25, further comprising: sending information indicative of an updated probability distribution of the set of candidate values for the field; and communicating second control signaling comprising a second encoded value for the field, wherein the second encoded value is encoded based on a second encoding scheme based on the information indicative of the updated probability distribution.

Clause 27: The method of any one of Clauses 17-26, further comprising obtaining information that indicates the encoding scheme is supported.

Clause 28: The method of any one of Clauses 17-27, further comprising sending information that indicates the network entity is capable of communication based on the encoding scheme.

Clause 29: The method of any one of Clauses 17-28, further comprising sending information that indicates to activate the encoding scheme.

Clause 30: The method of any one of Clauses 17-29, further comprising sending information that indicates to deactivate the encoding scheme.

Clause 31: The method of any one of Clauses 17-30, wherein the control signaling comprises radio resource control (RRC) signaling.

Clause 32: The method of any one of Clauses 17-31, further comprising sending information indicative of a second probability distribution of a second set of candidate values for the field.

Clause 33: The method of any one of Clauses 17-32, further comprising determining the probability distribution based on one or more of: a machine-learning model; a communication configuration; or a history of values of the field.

Clause 34: One or more apparatuses, comprising: one or more memories comprising executable instructions; and one or more processors configured to execute the executable instructions and cause the one or more apparatuses to perform a method in accordance with any one of clauses 1-33.

Clause 35: One or more apparatuses configured for wireless communications, comprising: one or more memories; and one or more processors, coupled to the one or more memories, configured to cause the one or more apparatuses to perform a method in accordance with any one of Clauses 1-33.

Clause 36: One or more apparatuses configured for wireless communications, comprising: one or more memories; and one or more processors, coupled to the one or more memories, configured to perform a method in accordance with any one of Clauses 1-33.

Clause 37: One or more apparatuses, comprising means for performing a method in accordance with any one of Clauses 1-33.

Clause 38: One or more non-transitory computer-readable media comprising executable instructions that, when executed by one or more processors of one or more apparatuses, cause the one or more apparatuses to perform a method in accordance with any one of Clauses 1-33.

Clause 39: One or more computer program products embodied on one or more computer-readable storage media comprising code for performing a method in accordance with any one of Clauses 1-33.

Clause 40: A user equipment (UE), comprising: a processing system that includes processor circuitry and memory circuitry that stores code and is coupled with the processor circuitry, the processing system configured to cause the UE to perform a method in accordance with any one of Clauses 1-16.

Clause 41: A network entity, comprising: a processing system that includes processor circuitry and memory circuitry that stores code and is coupled with the processor circuitry, the processing system configured to cause the network entity to perform a method in accordance with any one of Clauses 17-33.

Clause 42: One or more apparatuses configured for wireless communications, comprising: a processing system that includes one or more processors and one or more memories coupled with the one or more processors, the processing system configured to cause the one or more apparatuses to perform a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause the apparatus to:
obtain information indicative of a probability distribution of a set of candidate values for a field in control signaling, wherein the field represents a parameter that can be configured with a value selected from the set of candidate values; and
communicate control signaling comprising an encoded value for the field, wherein the encoded value is encoded based on an encoding scheme based on the information indicative of the probability distribution.

2. The apparatus of claim 1, wherein:
to communicate the control signaling, the processing system is configured to cause the apparatus to receive the control signaling; and
the processing system is configured to cause the apparatus to decode the encoded value based on the information indicative of the probability distribution.

3. The apparatus of claim 1, wherein:
to communicate the control signaling, the processing system is configured to cause the apparatus to send the control signaling; and
the processing system is configured to cause the apparatus to generate the encoded value based on the information indicative of the probability distribution.

4. The apparatus of claim 1, wherein to obtain the information indicative of the probability distribution, the processing system is configured to cause the apparatus to obtain the information indicative of the probability distribution via one or more of:
a radio resource control (RRC) message;
a system information block (SIB);
a master information block (MIB); or
a uniform resource locator (URL).

5. The apparatus of claim 1, wherein the information indicative of the probability distribution comprises the probability distribution.

6. The apparatus of claim 1, wherein the information indicative of the probability distribution comprises an order of the set of values by probability.

7. The apparatus of claim 1, wherein the information indicative of the probability distribution comprises a mapping of the set of candidate values to a set of code points.

8. The apparatus of claim 1, wherein the encoding scheme is configured to assign shorter code points to more statistically probable values of the set of candidate values, and longer code points to less statistically probable values of the set of candidate values.

9. The apparatus of claim 1, wherein the encoding scheme comprises Huffman coding.

10. The apparatus of claim 1, wherein the processing system is configured to cause the apparatus to:
obtain information indicative of an updated probability distribution of the set of candidate values for the field; and
communicate second control signaling comprising a second encoded value for the field, wherein the second encoded value is encoded based on a second encoding scheme based on the information indicative of the updated probability distribution.

11. The apparatus of claim 1, wherein the processing system is configured to cause the apparatus to:
obtain information that indicates the encoding scheme is supported.

12. The apparatus of claim 1, wherein the processing system is configured to cause the apparatus to:
send information that indicates the apparatus is capable of communication based on the encoding scheme.

13. The apparatus of claim 1, wherein the processing system is configured to cause the apparatus to:
obtain information that indicates to activate the encoding scheme.

14. The apparatus of claim 1, wherein the processing system is configured to cause the apparatus to:
obtain information that indicates to deactivate the encoding scheme.

15. The apparatus of claim 1, wherein the control signaling comprises radio resource control (RRC) signaling.

16. The apparatus of claim 1, wherein the processing system is configured to cause the apparatus to:
send information indicative of a second probability distribution of a second set of candidate values for the field.

17. An apparatus for wireless communications, comprising a processing system that includes one or more processors and one or more memories coupled with the one or more processors, the processing system configured to cause the apparatus to:
send information indicative of a probability distribution of a set of candidate values for a field in control signaling, wherein the field represents a parameter that can be configured with a value selected from the set of candidate values; and
communicate control signaling comprising an encoded value for the field, wherein the encoded value is encoded based on an encoding scheme based on the information indicative of the probability distribution.

18. The apparatus of claim 17, wherein the control signaling comprises radio resource control (RRC) signaling.

19. The apparatus of claim 17, wherein the processing system is configured to cause the apparatus to:
determine the probability distribution based on one or more of:
a machine learning model;
a communication configuration; or
a history of values of the field.

20. The apparatus of claim 17, wherein the information indicative of the probability distribution comprises the probability distribution.
